(19) United States
(12) Patent Application Publication
(10) Pub. No.: US 2024/0338740 A1
(43) Pub. Date: Oct. 10, 2024

(54) SYSTEM AND METHOD FOR INTERACTIVE PRODUCT INQUIRIES

(71) Applicant: Klevu Oy, Espoo (FI)

(72) Inventors: Niraj Aswani, St Albans (GB); Nilay Oza, London (GB)

(21) Appl. No.: 18/745,065

(22) Filed: Jun. 17, 2024

Related U.S. Application Data
(60) Provisional application No. 62/293,432, filed on Feb. 10, 2016.

(51) Int. Cl. G06Q 30/0601; G06F 16/951

(52) U.S. Cl. CPC G06Q 30/0625; G06F 16/951; G06Q 30/0641

(57) ABSTRACT

Disclosed below is a system and method for facilitating interactive product inquiry in an online ecommerce platform, which can be accessed from the product page itself. It allows users to switch to an interactive mode, wherein the users can ask any questions they have regarding the products and a conversational agent shall provide appropriate answers. This enables a user to get answers quickly unlike traditional systems. With ease of obtaining information without wasting any time, users can make a better decision while shopping.

### TECHNICAL FIELD

Various embodiments of the present disclosure relates generally to computer systems and processes for online ecommerce, and, more particularly to conversational artificial intelligence chat bots embedded with natural language processing, used in online ecommerce.

### BACKGROUND

E-Commerce has grown exponentially in the recent times with an ever growing number of online shopping transactions taking place every second through ecommerce storefronts. People prefer to search and buy their desired products online, from the comfort of their homes, rather than checking out the products at a physical store. Currently there exists multiple ecommerce storefronts and all of them are trying to provide as closest experience as possible to the customer as a real store. However while users are browsing through online stores, various doubts regarding the products, their characteristics etc may arise to the users.

In a real store a customer can browse through the available products on display and also engage in a conversation with the executives present in the store for more details regarding each of the products and clarify their doubts. But in an online ecommerce platform, the users have to browse to the entire page to get the relevant information. Sometimes, the pages are long and extensive and the user ends up wasting a lot of time. Product page usually has all important information about the product Reading through it is often time consuming and especially on hand-held devices, customers could find it hard to read through all the information. Customers are often interested in getting answers to their specific questions about the product immediately. If the answers are not available immediately, the probability of the user buying the said product decreases and the user experience becomes bad.

Another option available for the users on an online ecommerce portal is to type (i.e. ask) questions in the questions and answers segment and wait for someone to answer their specific question. In this case, the answer may be provided from other users as well. The main problem here is the waiting time. The users may not receive the answer that they are looking for immediately and they may have to wait for days and sometimes weeks. Also, the accuracy of the information provided is also questionable and most likely, the users may end up not buying the product.

While searching on online ecommerce platforms or browsing digital catalogues or even physically in an offline shop, shoppers often feel a need to talk to an agent to ask a few questions. Users often encounter uncertainties and questions when exploring product pages. The lack of immediate access to relevant information can hinder their purchasing decisions and lead to missed opportunities for businesses.

However, unlike in a physical offline shop where customer executives are present to answer the questions, currently, in online ecommerce platforms, there exists no solution wherein the user can immediately obtain correct and accurate answers to their questions. There is a pressing need for a solution that enables shoppers to ask questions directly on product pages, ensuring they receive prompt and accurate responses.

In the light of the above-mentioned shortcomings associated with existing in online ecommerce, it is highly desirable to have a system and method which could provide users a platform to facilitate interactive product inquiries and provide answers to their inquiries.

### SUMMARY

Embodiments of the present disclosure present technological improvements as solutions to one or more of the above-mentioned technical problems recognized by the inventor in conventional systems.

The present invention discloses a system and method for facilitating interactive product inquiries for users in online ecommerce, using a conversational Artificial Intelligence enabled chat bot. Further disclosed below is a system and method for facilitating users to ask product related questions and obtain accurate answers instantaneously. Additionally, the interactive product inquires can be triggered from the product page itself by the user at their will, using a feature provided product page.

In the primary embodiment of the present invention, it discloses a system and method comprising a hardware processor communicably coupled via a communication network with one or more user devices and a memory device wherein the processor enables a user to trigger an interactive product inquiry platform or a conversational agent via a graphical user interface present on the one or more user devices. The processor analyses the user inputs and questions using natural language processing and in turn obtains information from the memory device which pertains to the questions asked by the user. Additionally, the disclosed system and method enables the user to dynamically switch between the product page and the interactive user inquiry platform upon user's choice.

In one of the embodiments of the present invention, the ecommerce online stores provide product catalogues or product related information. The processor is further enabled to initiate a crawling of the product catalogues and process the said crawled information and identify various information present and categorises the information into different category and stores the same in the memory device. In another embodiment of the same invention, the processor is enabled to crawl through a product page in an online ecommerce page, identify various information present in the said page, categorise the information into different categories and store the same in the memory device.

Additional aspects, advantages, features and objects of the present disclosure would be made apparent from the and the detailed description of the illustrative embodiments construed in conjunction with the appended claims that follow.

While the systems and methods are illustrated by use of computer enabled embodiments and applications, they are equally applicable to virtually any portable or mobile communication device, including for example, computers laptops and mobile phones.

### BRIEF DESCRIPTION OF DRAWINGS

The summary above, as well as the following description of illustrative embodiments are better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 depicts a block diagram of an interactive product inquiry system as per the disclosed invention.

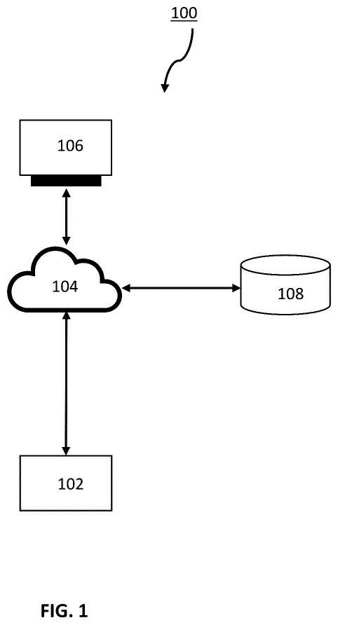

FIG. 2 depicts a flowchart depicting the method steps of the present invention.

FIG. 3 depicts a sample dynamic HTML page displayed on the graphical user interface of the user before activating the conversational agent as per the present disclosure.

FIG. 4 depicts a sample dynamic HTML page displayed on the graphical user interface of the user after activating the conversational agent as per the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

The present invention discloses a system and method for facilitating interactive product inquiries for users in online ecommerce, using a conversational Artificial Intelligence enabled chat bot. Further disclosed below is a system and method for facilitating users to ask product related questions and obtain accurate answers instantaneously. Additionally, the interactive product inquires can be triggered from the product page itself by the user at their will, using a feature provided product page.

In the primary embodiment of the present invention, it discloses a system 100 comprising a hardware processor 102 communicably coupled via a communication network 104 with one or more user devices 106 and a memory device 108 wherein the processor enables a user to trigger an interactive conversational agent via a graphical user interface present on the one or more user devices. The processor obtains information or answers from the memory device. Additionally, the disclosed system and method enables dynamically switch between the product page and the interactive user inquiry platform. The switching between the modes can happen from any mode to the other.

One of the primary embodiments of the present invention discloses a system for interactive product inquiries on an online platform, the system comprising a processor 102 configured to execute non-transitory machine-readable instructions, wherein the processor is configured to receive a request from a user to start a conversational agent on an online platform through the user device 106; start an interactive conversation session with the conversational agent based on the received request from the user, as an overlay on a page the user is browsing on the online platform; receive one or more inputs from the user through the conversational agent; analyse the one or more inputs from the user using one or more natural language processing algorithms, wherein the analysis of the one or more inputs comprises at least identifying an intent behind the one or more inputs from the user; retrieve one or more relevant information from a memory device 108, based on the analysis of the one or more inputs from the user, wherein the one or more relevant information is from the page the user is browsing on the online platform; generate one or more responses based on the retrieved one or more relevant information and a set of predefined algorithms; and present the one or more responses to the user through the conversational agent.

Another embodiment of the same invention discloses a system wherein the processor further configured to enable crawling of the page the user is browsing on the online platform when the request from the user to start a conversational agent is received, to crawl information; and store the crawled information from the page the user is browsing on the online platform, in the memory device. In another embodiment of the same invention, the system is configured to crawl product catalogue pages, identify relevant information and store the same in the memory device. Another embodiment of the same invention teaches a system wherein the system is fed with all the relevant information and the same is stored in the memory device.

In another embodiment of the same invention, the crawling of the information from the product page or the page in which the user is browsing is initiated when the user triggers or starts the conversational agent. This beneficially enables for the latest and most updated information to be crawled and subsequently provide the most relevant and latest responses to the users. When a user selects a specific product, the agent employs natural language processing (NLP) to analyze the product's detailed attributes—such as specifications, descriptions, and reviews—available within the search results.

In another embodiment of the same invention, one or more predefined algorithm used to generate the one or more responses is one or more natural language processing algorithms, one or more large language models and artificial intelligence. The same are used to analyze the inputs of the user and understand the context and intent behind the questions. Further, the same is used to predict or generate appropriate responses to the user inputs or questions.

In another embodiments of the same invention, the one or more inputs from the user is in one or more of text, voice, image and video format and the one or more responses generated by the conversational agent is in one or more of text, voice, image and video format. Thus, the user inputs may be, without limitation, a combination of or one of text, audio, image and video input. In another embodiment of the same invention, the user input is one or more of touch based input, wherein the touch based input is in response to the prompts generated and presented by the conversational agent to the user.

Another embodiment of the same invention teaches a system comprising a feedback mechanism wherein the user can rate the relevance of the one or more responses presented, which the conversational agent uses to refine future interactions for all users. Thereby, the system is “intelligent” and learning on the go to provide better and more accurate results to the users.

In another embodiment, the processor employs machine learning (ML) algorithms to adaptively refine the process of generating questions. This adaptive refinement is based on the analysis of accumulated user response data, which ensures that the questions become increasingly relevant and accurate over time, thereby improving the effectiveness of generated questions and user satisfaction. The processor collects data from user responses to previously generated questions. This includes direct answers, behavioral data (e.g., which questions led to longer interactions or higher engagement), and subsequent actions (such as purchases made after certain questions were asked). Besides direct responses, the processor also gathers contextual data regarding the circumstances under which questions were asked, including time, user demographics, and product specifics. Collected data are aggregated and categorized based on various parameters such as question type, user demographics, and interaction outcomes. One or more machine learning algorithms analyze these datasets to identify patterns and trends that indicate how different types of questions influence user decisions and engagement. Using the identified patterns, machine learning models are trained to predict the effectiveness of different types of questions in various contexts. This training process uses historical data to improve the models' predictive accuracy. The processor implements continuous or incremental learning processes, where the ML models are periodically updated with new data to refine their predictive capabilities and adjust to changing user preferences and market trends. Leveraging the insights from the machine learning models, the processor dynamically adjusts its question generation algorithms. This can involve changing the types of questions asked, the timing of the questions during an interaction, or the specificity of the questions based on the user's profile and past responses. Questions are increasingly personalized for users based on the learned preferences, improving relevance and the likelihood of positive user engagement.

By refining the generation of questions through machine learning based on accumulated user response data, the processor 102 can more accurately predict and address user needs. This reduces the need for users to conduct multiple, broad, or unfocused searches that typically require more computational resources to process. Enhanced question accuracy ensures that the search engine retrieves more relevant results on the first attempt. This minimizes the need for repeated searches and reduces the volume of data processed and transferred, thereby decreasing the computational load.

Moreover, improved question relevance means that fewer queries may reach the server for processing, as users find what they need more quickly. This reduces server load and can contribute to lower power consumption, as data centres consume significant energy primarily for power and cooling. With more predictable user queries and behaviors, caching mechanisms can be optimized to store and retrieve data more efficiently. Frequently accessed data based on common queries identified through machine learning can be cached more strategically, reducing the time and energy needed to fetch data from primary storage. By streamlining the number of necessary computations, the processor requires less energy to operate at an optimal level. This is especially beneficial for large-scale eCommerce platforms, where slight efficiencies in search algorithms can lead to significant reductions in overall energy consumption.

The one or more responses generated are specifically tailored to the context of the user's input in the conversational agent product. For example, if the user has shown interest in a particular type of product but wants additional information on certain attributes like size or color or user reviews, the processor may generate responses based on the available information it has crawled from the page or the product catalogue and provide the relevant responses/information. The one or more responses are designed to clarify the user's requirements, akin to a shopping assistant in a brick and mortar store. The conversational agent thus provides additional information that might be pertinent based on the user's interaction with the ecommerce platform, or help narrow down choices by highlighting key differentiators among products. This results in lesser number of search queries and operations by the user in finding relevant product and a better shopping experience overall.

Throughout the disclosure the term “interactive product inquiry platform” and the term “conversational agent” refers to a software module functionally operable to receive text, audio, image and video inputs from users and also output text, audio, image and video responses on the basis of and/or corresponding to and in response to the inputs received from the users. The conversational agent is an artificial intelligence enabled platform, comprising of one or more natural language processing algorithms, large language models and predictive algorithms. Without limitation, just for illustration purposes, ChatGPT is an example of a conversational agents. The disclosed system comprises of one such conversational agents.

In one of the embodiments of the present invention, the ecommerce online stores provide product catalogues or product related information. The processor is enabled to process the said information and identify various information present and categorises the information into different category and stores the same in the memory device. In another embodiment of the same invention, the processor is enabled to crawl through a product page in an online ecommerce page, identify various information present in the said page, categorise the information into different categories and store the same in the memory device.

With the increasing use of chatbots and conversational AI agents, businesses are looking for new ways to engage customers and provide them with personalized and relevant experiences. One way to do this is by allowing shoppers to switch from a standard question answer section in the product page in an online ecommerce shop and replace it with interactive product inquiry platform. In one of the embodiments of the present invention, this is done using an integrated toggle switch within the standard or traditional product page, which can be used to trigger the interactive product inquiry page.

Without limiting the scope of the present invention, the present invention solves various problems associated with existing online platforms. Shoppers may have various queries related to the products they are browsing and they need accurate answers. Also, they may not have the time or the patience to read through the entire product page or the product catalogue. This is solved using the present invention by using a conversational agent or the chat bot which is used to answer the questions of the users. The system and method disclosed enable users to obtain answers to their questions regarding one or more products from a conversational agent, by leveraging AI-powered automation.

In one of the embodiment of the present invention, the conversational agent activation trigger is displayed as overlay icon on top of the product image, closer to the title or any other place as decided, anywhere on the page serving as a visual prompt for shoppers to seek assistance. This easily recognizable button ensures a seamless user experience. Clicking on the overlay icon opens a chat window interface, where shoppers can ask their questions. The interface is designed for natural language input, enabling shoppers to communicate their queries in a conversational manner.

The core innovation behind the disclosed system and method lies in its AI conversational agent, which leverages advanced Natural Language Processing (NLP) and machine learning techniques and the GPT models for their Generative capabilities. The AI agent automatically analyzes the questions asked by shoppers, identifies the intent behind each query, and retrieves relevant information from the memory device. The processor 102 utilizes a set of predefined algorithms designed to analyze the user input in conjunction with relevant product data. The set of predefined algorithms includes components of natural language processing to understand the intent and content of the user's input, as well as data mining techniques to extract pertinent information from a large dataset of product information.

The processor 102 employs artificial intelligence based algorithms to analyse this data and extract meaningful insights about what additional information the user might require or what specific product features are drawing the user's interest. The processor analyzes the user input and the accessed data to determine the context of the user's queries or selections.

Further, in additional aspects of the present invention, the system and methods disclosed herein has updated context of the user's browsing history, the user's and other users' product specific browsing history and related product browsing history, which enables the interactive product inquiry platform to be user specific and also optionally product specific as well.

Additionally, one of the embodiment of the present system and method also allows the user to ask a question. When a question is asked, the frontend delivers the question and the URL of the page to the backend. The processor, on receiving this URL initiates a crawling process to gather essential information from the page and continues to build a comprehensive product database. If the page was crawled earlier, the information about the crawled page is utilised. The said information is categorised and stored in the memory device. It is then used to answer the questions asked by the users.

This database here serves as a knowledge repository that stores details about various products, their variants, specifications and more. The processor regularly updates and refines this database to ensure it remains up-to-date and accurate.

In another embodiment of the same invention, the system obtains the information regarding a product from a product catalogue. It is then categorised and stored in the memory device.

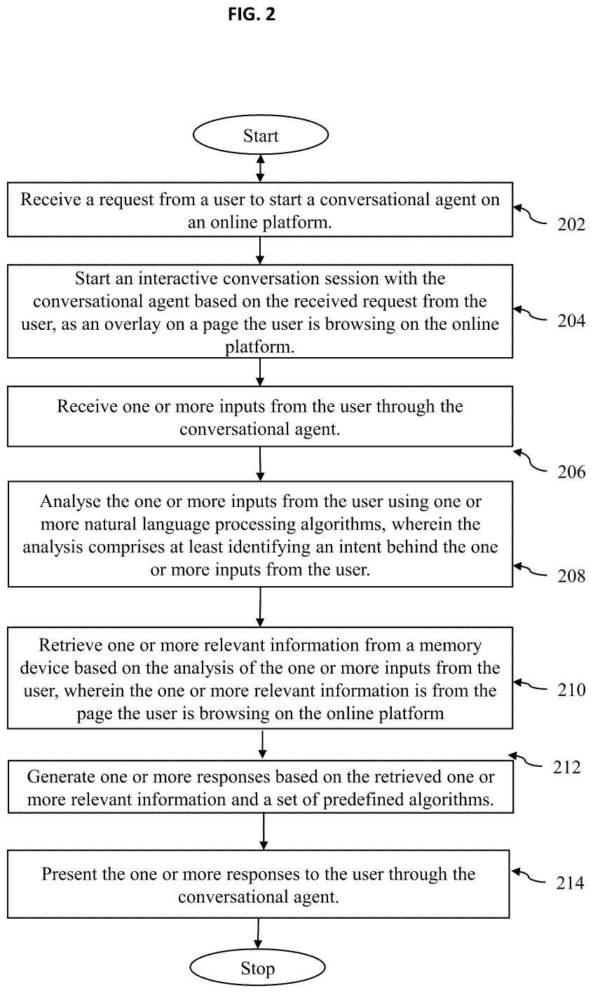

Another primary embodiment of the present invention discloses a computer implemented method for interactive product inquiries on an online platform. FIG. 2 depicts a flowchart of the method steps in the present invention. At a step 202, the processor receives a request from a user to start a conversational agent on an online platform. At a step 204, an interactive conversation session with the conversational agent based on the received request from the user, as an overlay on a page the user is browsing on the online platform is started. At a step 206, one or more inputs from the user through the conversational agent is received. At a step 208, the one or more inputs from the user using one or more natural language processing algorithms is analysed, wherein the analysis of the one or more inputs comprises at least identifying an intent behind the one or more inputs from the user. At a step 210, one or more relevant information is retrieved from a memory device, based on the analysis of the one or more inputs from the user, wherein the one or more relevant information is from the page the user is browsing on the online platform. At a step 212, one or more responses is generated based on the retrieved one or more relevant information and a set of predefined algorithms. At a step 214, the one or more responses is presented to the user through the conversational agent.

The method disclosed further comprises enabling crawling of the page the user is browsing on the online platform when the request from the user to start a conversational agent is received, to crawl information; and storing the crawled information from the page the user is browsing on the online platform, in the memory device.

The conversational agent goes beyond answering direct inquiries about the current product. It harnesses the wealth of information in the database, providing valuable insights on other available options, facilitating product comparisons, and suggesting alternative products based on the preferences expressed by the shopper. This intelligent recommendation system enhances the shopper's exploration journey, empowering them with a broader range of choices and helping them discover products that align with their needs and preferences.

In another embodiment of the same invention, the conversational agent or the chat bot can help users while they are still browsing by proactively offering help and answering any questions they may have and allowing them to switch to the interactive product inquiry mode. This can help reduce bounce rates and increase engagement, as shoppers are more likely to stay on the website or mobile app if they feel that they have access to someone answering their questions in a natural human language.

Yet another embodiment of the same invention also discloses One or more non-transitory storage media comprising computer-executable instructions that, when executed by a processor, causes the processor to receive a request from a user to start a conversational agent on an online platform; start an interactive conversation session with the conversational agent based on the received request from the user, as an overlay on a page the user is browsing on the online platform; receive one or more inputs from the user through the conversational agent; analyse the one or more inputs from the user using one or more natural language processing algorithms, wherein the analysis of the one or more inputs comprises at least identifying an intent behind the one or more inputs from the user; retrieve one or more relevant information from a memory device, based on the analysis of the one or more inputs from the user, wherein the one or more relevant information is from the page the user is browsing on the online platform; generate one or more responses based on the retrieved one or more relevant information and a set of predefined algorithms; and present the one or more responses to the user through the conversational agent.

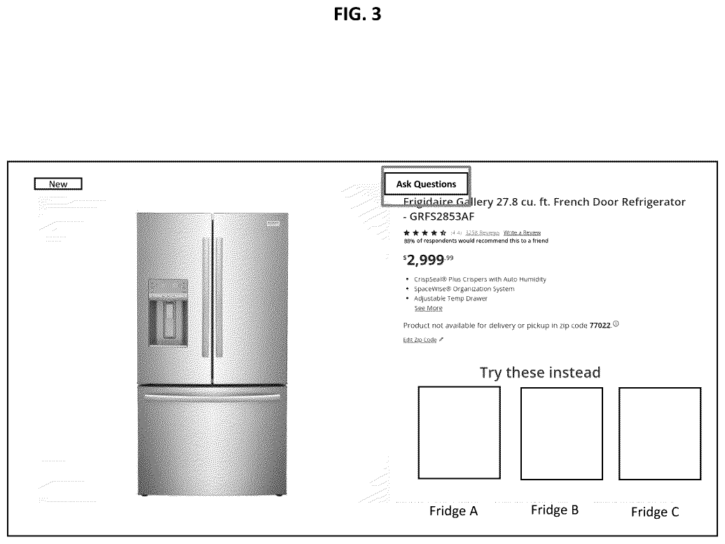

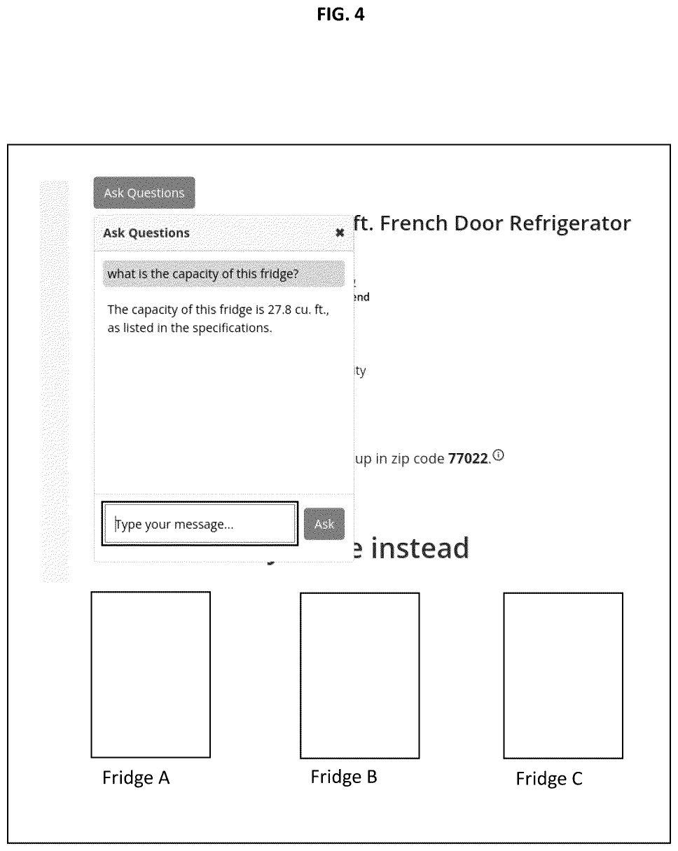

FIG. 3 depicts a sample dynamic HTML page displayed on the graphical user interface of the user before activating the conversational agent as per the present disclosure. Without limitation, the user can click on the “Ask Question” or such other buttons which activates or triggers the conversational agent. Further, FIG. 4 depicts a sample dynamic HTML page displayed on the graphical user interface of the user after activating the conversational agent as per the present disclosure. The user can ask any questions and the conversational agent responds with appropriate answers.

The disclosed system and method also allows the users to switch back to the standard search or browse mode whenever the user desires. In such scenarios, the option to switch back to quick search allows shoppers to continue their search independently or try a different search query that may provide better results. This ensures that shoppers are not left feeling frustrated or confused, which can negatively impact their overall experience. Additionally, based on the users' questions, the interactive inquiry platform may also suggest other alternative products as well and provide their respective links.

Additionally, offering a switch back to quick search can also help businesses gather valuable insights into the types of questions or queries that the interactive inquiry platform is unable to answer. This can help them identify knowledge gaps and improve the conversational agent's capabilities over time, ensuring that it becomes increasingly effective and efficient in helping shoppers.

Additional or less units can be included without deviating from the novel art of this disclosure. In addition, each unit can include any number and combination of sub-units, and systems, implemented with any combination of hardware and/or software units.

Throughout more disclosure the term “user device” refers to devices such as, but not limited to, a mobile phone, tablet, a laptop, a personal computer connected to a widely accessible network such as the Internet, any portable computing device connected to a widely accessible network such as the Internet, or any graphical user interface enabling a user to enter an input, a portable communication device, or a personal digital assistant connected to the one or more data communication network.

Method steps of the invention may be performed by one or more computer processors executing a program tangibly embodied on a computer-readable medium to perform functions of the invention by operating on input and generating output. Suitable processors include, by way of example, computers, laptops, mobile phones, both general and special purpose microprocessors.

As an example, without limiting the scope of the invention, the user is searching for refrigerator. User will enter the required criteria for the refrigerator in the search bar. Typically, an ecommerce platform generates a list of refrigerators available. The user can select one particular refrigerator and a detailed product page opens. Here, the user may seek additional information regarding the refrigerator, such as power consumption, available colors, volume or capacity, etc. Such queries can be accurately answered by the conversational agent.

Throughout this disclosure, the term online ecommerce platforms has been used, without limitation. The same may be applicable to any type of online platforms, websites, internet based applications and other internet based interfaces. Without limitation, it may refer to not just ecommerce and shopping but for other purposes as well. For illustration purposes only, without limiting the scope of the invention, the system and methods can be integrated with online gaming platforms and websites, food ordering and review applications, online stock markets, internet banking, etc.

Another embodiment of the same invention also provides for personalized assistance for the users. By utilizing the database of product pages and the shoppers' previous interactions, the application provides tailored recommendations and suggestions that cater to their specific requirements. This personalized approach enhances the shoppers' experience by guiding them towards products that closely align with their preferences and increasing the likelihood of a satisfying purchase.

Additionally, the present invention supports question answering in different languages. When prompted by the shopper, the system seamlessly switches to the desired language, enabling them to ask their questions and receive responses in their preferred language. This feature promotes inclusivity and expands the reach of the application to a broader global audience. It eliminates language barriers, ensuring that shoppers from diverse linguistic backgrounds can engage with the system and obtain relevant information in a language they are comfortable with. By accommodating multiple languages, the application enhances accessibility, improves shopper satisfaction, and fosters a more inclusive and user-friendly shopping experience for shoppers worldwide. It offers multiple options for providing language prompts. Shoppers can either explicitly choose the source and target language or directly input the desired target language within their question. In cases where no explicit language prompt is provided, the system employs automatic language detection to identify the language of the question. It then generates answers in the detected language, ensuring seamless communication and accurate responses. This intelligent language handling capability enhances shopper convenience, enabling them to effortlessly engage with the application and receive answers in their preferred language, regardless of whether they explicitly specify the language or rely on automatic detection.

Another embodiment of the present invention also caters to scenarios where the conversational agent is unable to provide an answer due to the absence of information on the page. In such cases, the application offers a valuable feature: shoppers can choose to leave a message for a human agent, connect with an available live agent for immediate assistance, or opt to leave the question for other shoppers to answer on the page. This capability ensures that shoppers have multiple avenues to seek help and receive the support they need, enhancing their overall experience and satisfaction.

In an alternative embodiment of the same invention, the said invention is built using a distributed ledger based platform such as blockchain. The system and method facilitates online ecommerce shopping using cryptocurrency. Additionally, smart contracts can be added wherein the smart contracts would facilitate buying and selling based on the set conditions. Having a blockchain based platform ensures that the transactions can be tracked and no one can mis-use the present system.

Beneficially, some of the embodiments of the present technical solution may also be modified to provide benefits including but not limited to (a) allows the application to handle a large volume of inquiries simultaneously; (b) Availability of the conversational agent round the clock ensures shoppers can access assistance at any time, enhancing customer satisfaction; (c) With the conversational agent's automation capabilities, shoppers receive immediate responses to their questions without having to wait for human intervention. This ensures a fast and efficient shopping experience, enabling shoppers to make informed decisions quickly; (d) easy shopping experience because of the questions and answers prompted by the chat bot is based upon the user's history and specific to products.

Any examples or illustrations given herein are not to be regarded in any way as restrictions on, limits to, or express definitions of, any term or terms with which they are utilized. Instead, these examples or illustrations are to be regarded as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion.

It will be understood that the application is not limited to the embodiments disclosed, but is capable of numerous rearrangements, modifications, and substitutions as set forth.

At least portions of the functionalities or processes described herein can be implemented in suitable computer-executable instructions. It will be appreciated that features of the present disclosure are susceptible to being combined in various combinations and additional features may be introduced without departing from the scope of the present disclosure.

1. A system for interactive product inquiries on an online platform, the system comprising:
a processor configured to execute non-transitory machine-readable instructions, wherein the processor is configured to:
receive a request from a user to start a conversational agent on an online platform;
start an interactive conversation session with the conversational agent based on the received request from the user, as an overlay on a page the user is browsing on the online platform;
receive one or more inputs from the user through the conversational agent;
analyse the one or more inputs from the user using one or more natural language processing algorithms, wherein the analysis of the one or more inputs comprises at least identifying an intent behind the one or more inputs from the user;
retrieve one or more relevant information from a memory device, based on the analysis of the one or more inputs from the user, wherein the one or more relevant information is from the page the user is browsing on the online platform;
generate one or more responses based on the retrieved one or more relevant information and a set of predefined algorithms; and
present the one or more responses to the user through the conversational agent.

2. The system of claim 1 wherein the processor further configured to:
enable crawling of the page the user is browsing on the online platform when the request from the user to start a conversational agent is received, to crawl information; and
store the crawled information from the page the user is browsing on the online platform, in the memory device.

3. The system of claim 1 wherein the predefined algorithm used to generate the one or more responses is one or more natural language processing algorithms, one or more large language models and artificial intelligence.

4. The system of claim 1 wherein the one or more inputs from the user is in one or more of text, voice, image and video format.

5. The system of claim 1 wherein the one or more inputs from the user is a touch based inputs, corresponding to one or more prompts presented by the conversational agent.

6. The system of claim 1 wherein the one or more responses generated by the conversational agent is in one or more of text, voice, image and video format.

7. The system of claim 1, further comprising a feedback mechanism wherein the user can rate the relevance of the one or more responses presented, which the conversational agent uses to refine future interactions for all users.

8. A computer implemented method for interactive product inquiries on an online platform, the method comprising:
receiving a request from a user to start a conversational agent on an online platform;
starting an interactive conversation session with the conversational agent based on the received request from the user, as an overlay on a page the user is browsing on the online platform;
receiving one or more inputs from the user through the conversational agent;
analysing the one or more inputs from the user using one or more natural language processing algorithms, wherein the analysis of the one or more inputs comprises at least identifying an intent behind the one or more inputs from the user;
retrieving one or more relevant information from a memory device, based on the analysis of the one or more inputs from the user, wherein the one or more relevant information is from the page the user is browsing on the online platform;
generating one or more responses based on the retrieved one or more relevant information and a set of predefined algorithms; and
presenting the one or more responses to the user through the conversational agent.

9. The method of claim 8 further comprising:
enabling crawling of the page the user is browsing on the online platform when the request from the user to start a conversational agent is received, to crawl information; and
storing the crawled information from the page the user is browsing on the online platform, in the memory device.

10. The method of claim 8 wherein the predefined algorithm used to generate the one or more responses is one or more natural language processing algorithms, one or more large language models and artificial intelligence.

11. The method of claim 8 wherein the one or more inputs from the user is in one or more of text, voice, image and video format.

12. The method of claim 8 wherein the one or more inputs from the user is a touch based inputs, corresponding to one or more prompts presented by the conversational agent.

13. The method of claim 8 wherein the one or more responses generated by the conversational agent is in one or more of text, voice, image and video format.

14. The method of claim 8, further comprising a feedback mechanism wherein the user can rate the relevance of the one or more responses presented, which the conversational agent uses to refine future interactions for all users.

15. One or more non-transitory storage media comprising computer-executable instructions that, when executed by a processor, causes the processor to:
receive a request from a user to start a conversational agent on an online platform;
start an interactive conversation session with the conversational agent based on the received request from the user, as an overlay on a page the user is browsing on the online platform;
receive one or more inputs from the user through the conversational agent;
analyse the one or more inputs from the user using one or more natural language processing algorithms, wherein the analysis of the one or more inputs comprises at least identifying an intent behind the one or more inputs from the user;
retrieve one or more relevant information from a memory device, based on the analysis of the one or more inputs from the user, wherein the one or more relevant information is from the page the user is browsing on the online platform;
generate one or more responses based on the retrieved one or more relevant information and a set of predefined algorithms; and
present the one or more responses to the user through the conversational agent.
